(19) United States
(12) Patent Application Publication
(10) Pub. No.: US 2014/0344262 A1
(43) Pub. Date: Nov. 20, 2014

(54) SYSTEM AND METHOD FOR IDENTIFYING OBJECTS

(71) Applicant: Merav Rachlevsky VARDI, (US)

(72) Inventors: Merav Rachlevsky Vardi, New York, NY (US); Hyman Ofri, Thornhill (CA); Saar Golde, Forest Hills, NY (US); Uri Shaham, New Haven, CT (US)

(21) Appl. No.: 14/368,297

(22) PCT Filed: Dec. 23, 2012
(86) PCT No.: PCT/IL12/50549

§ 371 Date: Jun. 23, 2014

Related U.S. Application Data
(60) Provisional application No. 61/578,919, filed on Dec. 22, 2011.

(51) Int. Cl. G06F 17/30

(52) U.S. Cl. CPC G06F 17/3053
USPC 707/723; 707/748

(57) ABSTRACT

A system and method for identifying objects is provided herein. The method includes the following steps: receiving an object indication featuring an object and storing the indication as an identification task in an identification task subdatabase; sending an identification task to a plurality of raters of a list of raters stored in a raters subdatabase; receiving replies submitted by raters including presumed identifications of the object and storing the replies in a submitted replies subdatabase; and determining an identity of an object based on the submitted replies and a recorded skill level of the submitting raters. The identification task may be in a form of a game that may or may not provide an award to the user. The correct answer to the game is pre-identified and the answer from the user is used to rate the raters, or to assist identifying an unidentified object by a pre-identified one.

### FIELD OF THE INVENTION

The present invention relates to computerized object identification, and more particularly to computerized object identification by participants in a game or a social network.

### SUMMARY OF THE INVENTION

Embodiments of the present invention may provide a system for identifying objects including: a database and a processor to receive an object indication featuring an object and to determine an identity of an object. The term object should be interpreted broadly to include images, text, sounds and the like.

According to embodiments of the present invention, the processor may determine an identity of an object by: sending an identification task to a plurality of raters of a list of raters stored in the database; and receiving replies submitted by raters including presumed identifications of the object, wherein the determining of an identity of an object may be based on the submitted replies and a recorded skill level of the submitting raters.

Additionally according to embodiments of the present invention the processor may determine an identity of an object by: rating each reply based on number of submissions of the reply and a recorded skill level of the submitting rater stored in the database; and generating a survey including a plurality of most highly rated replies, for the raters to vote for the presumed identity of the object.

The database according to embodiments of the present invention may include, for example, a raters subdatabase to store rater details and skill levels of raters, an identification tasks subdatabase to store uploaded object indications, a submitted replies subdatabase to store replies to the identification task submitted by raters and ratings of the replies, a surveys subdatabase to store generated serveys and a votes subdatabase to store votes to the serveys.

Additionally, embodiments of the present invention may provide a method for identifying objects including: receiving an object indication featuring an object and storing the indication as an identification task in an identification task subdatabase; sending an identification task to a plurality of raters of a list of raters stored in a raters subdatabase; receiving replies submitted by raters including presumed identifications of the object and storing the replies in a submitted replies subdatabase; and determining an identity of an object based on the submitted replies and a recorded skill level of the submitting raters.

Determining an identity of an object according to embodiments of the present invention may include: rating each reply based on number of submissions of the reply and a recorded skill level of the submitting rater stored in a raters subdatabase, and storing the rating in the submitted replies subdatabase; and generating a survey including a plurality of most highly rated replies, for the raters to vote for the presumed identity of the object, and storing the survey in a surveys subdatabase.

More specifically, determining an identity of an object according to embodiments of the present invention may include estimating the coverage of density of replies to be received in response to a certain identification task. Once the coverage exceeds a first threshold, which may be a certain predetermined coverage of replies density or percentage of the estimated expected number of different replies, the method may include generating a survey by selecting the top rated replies. The estimating of the coverage of density of replies may be performed, in some embodiments, after each group of submissions, grouped by number of submissions or timing of submission. In other embodiments, the estimating is performed after each new submission of a reply. In some embodiments, the method may include weighting each vote by an established skill level of the voting rater.

Additionally, the method may include, based on received votes stored in a votes database and estimation of skill levels of the raters, evaluating the probability distribution that each of the replies in the survey is the correct answer; and once the probability that one of the replies is the correct answer passes a second threshold, labeling the reply having the highest probability to be the correct answer as the identity of the object. The evaluating of the probability distribution that each of the replies in the survey is the correct answer may be performed, in some embodiments, after each group of vote submissions, grouped by number of submissions or timing of submissions. In other embodiments, the evaluating may be performed after each submission of a vote.

The estimation of coverage of density of replies in embodiments of the present invention may be performed by a statistical algorithm for density estimation, or Capture-Recapture algorithm. For example, the estimation of coverage of density of replies may be performed by statistical parameter estimation algorithm or by analyzing for several different time periods the number of different replies submitted in each time period. Additionally or alternatively, the estimation may be performed by analyzing the number of repeated submitted replies between the different time periods. The replies may be weighted according to the skill levels of the raters.

The method according to embodiments of the present invention may include several more steps. For example, comparing the replies each rater submitted to the reply labeled as the correct answer, evaluating the level of difficulty of the identification task, and possibly establishing a skill level of a rater based on the evaluated level of difficulty of the identification task. The skill level may be stored in the raters subdatabase. The level of difficulty of the identification task may be stored in the identification tasks subdatabase.

According to some embodiments, the identification task provided by the administrator of the proposed system may be in a form of a game that may or may not provide an award to the user. In this embodiment, the correct answer to the game or quiz, is pre-identified and so the answer from the user is used in order to rate the raters, or to assist identifying an unidentified object by a pre-identified one.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for identifying objects according to embodiments of the present invention;

FIG. 2 is a schematic flow-chart illustration of a method for identifying objects according to embodiments of the present invention;

FIG. 3 is a schematic flow-chart illustration of a method for establishing a skill level for a rater for identifying objects according to embodiments of the present invention; and

FIG. 4 is a schematic flow-chart illustration of a method for identifying objects according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the present invention may provide a system and method for identifying objects, people, places, events, etc. in visual and/or auditory indications such as, for example, images, videos, text and/or sound. A method according to embodiments of the present invention may include receiving answers from multiple registered users, e.g.

raters, about a visual and/or auditory indication, for example answers identifying an object, person, place and/or event based on the visual and/or auditory indication, and/or answers to questions regarding the object, people, place and/or event. Embodiments of the present invention may include multi-stage processing of raters' answers, for example by weighting differently answers from different raters, for example according to their established skill level of answering similar questions. Raters' skill levels may be evaluated based on their performance in answering questions in the past. Having the objects, people, etc. identified by multiple raters along time may enable a more precise identification than identification by any single rater.

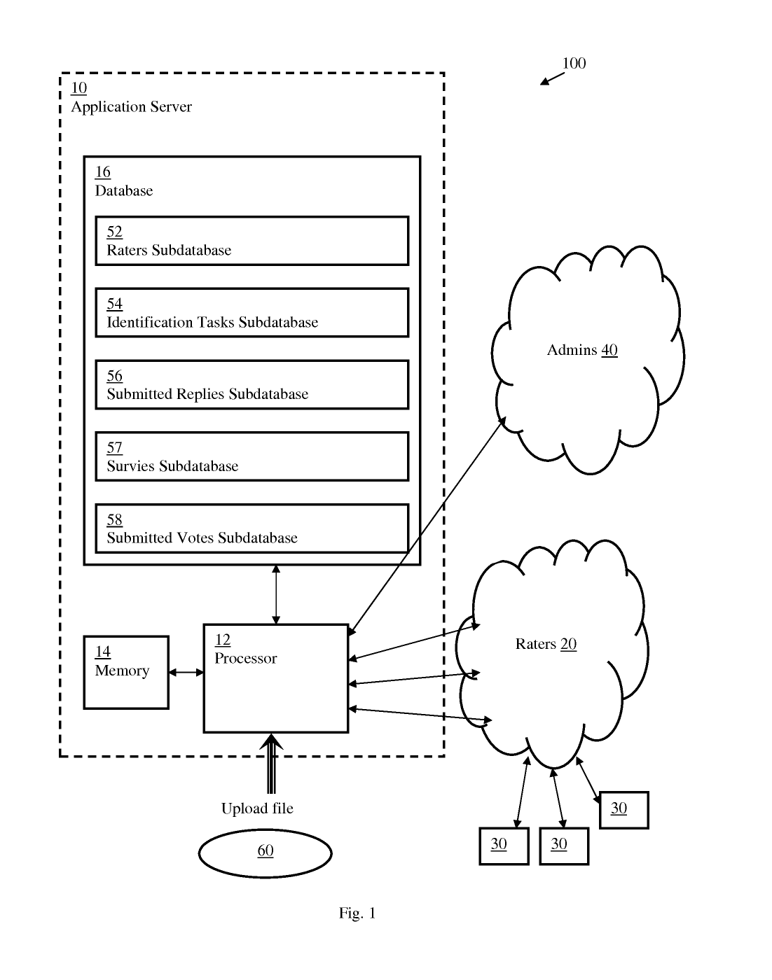

Reference is now made to FIG. 1, which is a schematic illustration of a system 100 for identifying objects according to embodiments of the present invention. System 100 may include an application server 10, which may be controlled by a service provider, and user devices 30. User devices 30 may include stationary working stations, computers, or mobile devices such as, for example, mobile phones, smart-phones, tablet computers, etc. Application server 10 may include a processor 12, a memory 14, a database 16 and user devices 30. Database 16 may be included in memory 14, or may be stored in another storage medium. Memory 14 may include an article such as a computer or processor readable non-transitory storage medium, such as for example a memory card, a disk drive, or a USB flash memory encoding, including or storing instructions, e.g., computer-executable instructions, such as, for example, application/software items downloaded from an application server. When executed by a processor or controller such as processor 12, the instructions stored and/or included in memory 14 may cause the processor or controller to carry out methods disclosed herein.

Processor 10 may receive an indication featuring an object 60, such as, for example, an image, video, text and/or sound. The object indication may be in the form of a file uploaded by a user, for example by a user device 30, such as for example, an image, video, text and/or sound file. Processor 12 may store uploaded object indications in database 16, for example in an identification task subdatabase 54. Processor 12 may send the object indication as an identification task to a plurality of raters 20, e.g. to accounts of raters 20 registered to a designated application, for example, application users that may be registered in advance to application server 10. The object indications may be displayed to raters 20, for example, by user devices 30. A list and/or details of raters 20 may be stored in database 16, for example in a raters subdatabase 52. In addition, or alternatively, raters 20 may include automated classifiers such as, for example, an image, sound and/or text recognition machine and/or software.

In response to the indications sent by processor 12, raters 20 may submit their identifications of the object 60, which may be stored in a submitted replies subdatabase 56. For example, a rater may receive an image of an object such as, for example, a bag, a car or a dress etc. and identify in reply the brand name, model name and/or the marketing company related to the object. Processor 12 may decide the correct answer, e.g. the correct brand/model/company name, by analyzing the submitted replies from multiple raters 20, for example by a decision algorithm as described in detail herein below.

Each reply submission may be stored in replies subdatabase 56 along with a time stamp indicating time of submission of the reply. Additionally, each reply submission may be stored along with a weight given to the submission according to an established skill level of the rater, as described in detail herein below. Additionally, each reply may be stored along with number of repetitions of the same and/or similar replies received from various users, for example weighted by established skill levels of raters 20. Same and/or similar replies received from various users in response to a certain object indication, for example within a certain period of time, may be grouped together in replies subdatabase 56. Similar replies may include replies with different spellings of the same answer, synonyms, similar entities according to a pre-determined ontology, and so forth.

Raters subdatabase 52 may include an established skill level associated with each rater, e.g. recorded in subdatabase 52 in relation to each rater. The skill level of each rater may be established and/or estimated based on the accuracy of the rater's replies in the past. Processor 12 may weight the submitted replies according to an established skill level that may be associated with each rater, e.g. by giving more weight in the decision algorithm to replies made by raters with higher recorded skill level, e.g. a record of more accurate submissions.

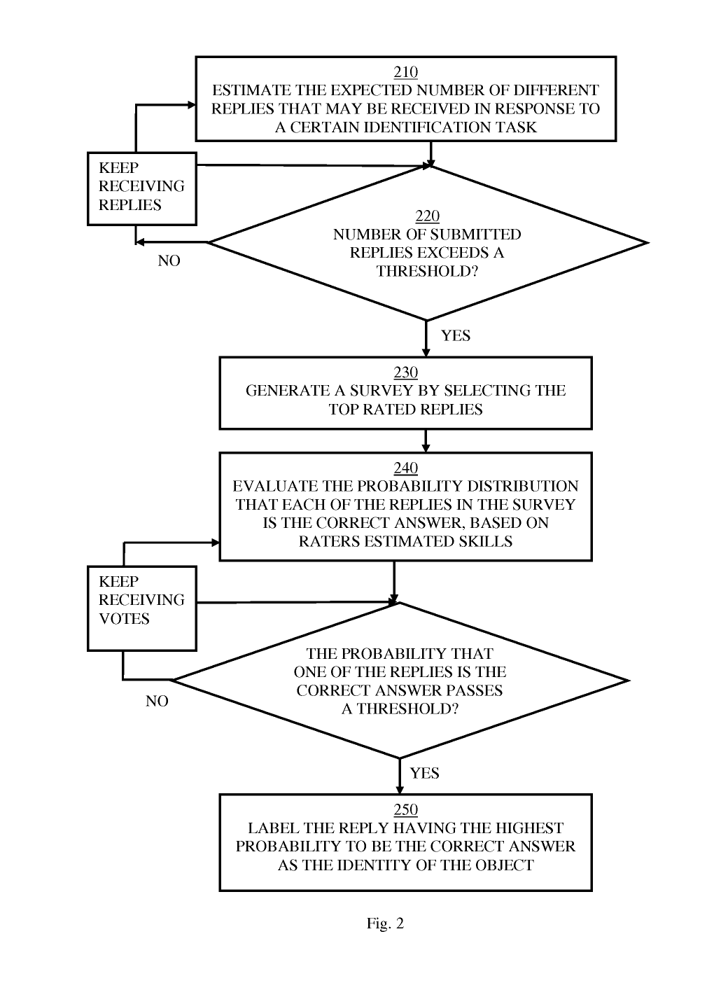

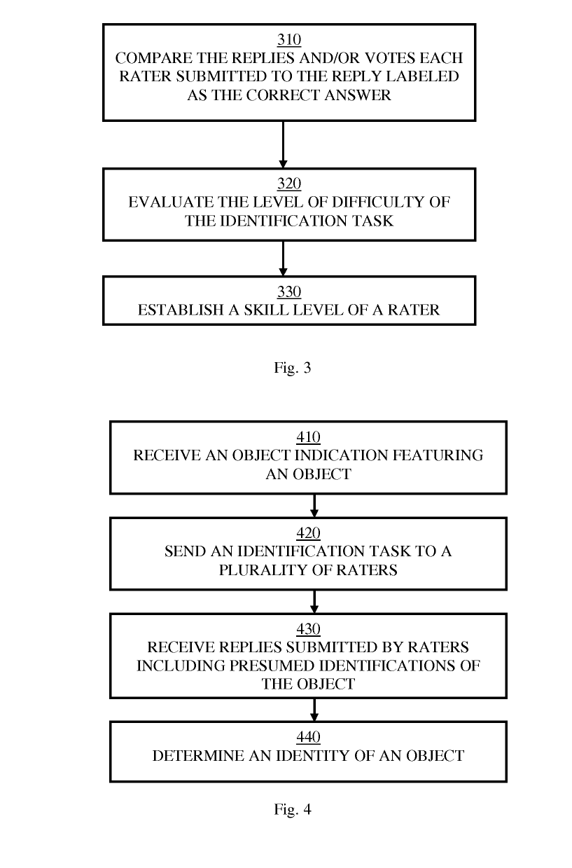

As discussed above, processor 10 may receive an indication featuring an object 60, such as, for example, an image, video, text and/or sound. The object indication may be in the form of a file uploaded by an administrator 40. In some embodiments of the present invention, administrators 40 may upload files featuring pre-identified items that would bypass the process in FIG. 2 and serve as an initial set of survey items for the processes in FIGS. 3 and 4. In other embodiments, the indication featuring an object 60 may undergo the processes of FIGS. 2, 3 and 4 as described herein for accurate identification of object 60. For example, in some embodiments, administrators 40 may upload files featuring pre-identified items to receive replies from raters and thus, for example, establish initial skill levels for the raters, to be stored at raters database 52.

According to some embodiments, the identification task provided by administrator 40 may be in a form of a game that may or may not provide an award to the user. In this embodiment, the correct answer to the game or quiz, is pre-identified and so the answer from the user is used in order to rate the raters, or to assist identifying an unidentified object by a pre-identified one.

According to embodiments of the present invention, processor 12 may determine a correct identity of an object 60 by a two-stage decision algorithm. In the first stage of the decision, raters 20 may submit replies, i.e. their presumed identifications of the object. In this stage, the identification task is open, i.e. the raters may submit substantially any reply and/or the reply may be limited to a finite dictionary of allowed replies, which may be stored in a replies subdatabase 56 as described herein. In the second stage of the decision, processor 12 may present to raters 20 a survey including the most highly rated replies submitted during the first stage, for the raters to vote for the presumed correct answer, i.e. the presumed correct identity of the object 60. The generated surveys may be stored in a surveys subdatabase 57 in database 16. The votes submitted by the raters may be stored in a votes subdatabase 58 in database 16.

Reference is now made to FIG. 2, which is a schematic flow-chart illustration of a method for identifying objects according to embodiments of the present invention. In some embodiments of the present invention, in a first stage of decision, as indicated in block 210, processor 12 may estimate by a statistical algorithm the coverage of density of replies and/or the expected number of different replies that may be received in response to a certain identification task by received replies. The estimation may be performed continuously, i.e. after each new submission of a reply, or periodically, i.e. after each group of submissions, grouped by number of submissions or timing of submission. Such estimation may be performed either by parameter estimation of some selected distributions, or by a Capture-Recapture algorithm. The Capture-Recapture algorithm may use, for example, the time stamps associated with the replies. The statistical algorithm may estimate the coverage of replies density by assuming that the replies distribution belongs to some distributions family governed by any number of parameters. After statistical methods for parameter estimation are applied, the coverage of the density of replies by replies that were already submitted can be estimated. Alternatively, the statistical algorithm may estimate the expected number of different replies by, for example, analyzing the number of repeated submitted replies between the different time periods. The statistical algorithm may estimate the expected number of different replies by, for example, analyzing for several different time periods the number of different replies submitted in each time period, and/or by analyzing the number of repeated submitted replies between the different time periods. The statistical algorithm may, for example, be weighted according to the estimated skill levels of the raters, e.g. weight the different replies according to the skill levels of the raters. Then, the proportion of replies that were already received, e.g. the coverage of replies density, can be estimated.

Once the coverage of replies density exceeds a certain pre-determined threshold, or the number of replies already received exceeds a certain pre-determined threshold such as, for example, a certain percentage of the estimated expected number of different replies, as indicated in block 220, processor 12 may initiate a second stage of decision. Once initiating the second stage of decision, the identification task may be labeled in identification tasks subdatabase 54 as completed.

In a second stage of decision, as indicated in block 230, processor 12 may generate a survey by selecting the top rated replies, for example, replies that are rated above a predetermined or calculated threshold, and/or the top rated replies that constitute a certain percentage of the submitted replies and/or of the estimated expected number of different replies. Processor 12 may rate each reply based on number of submissions of the reply (including same and/or similar replies, as discussed above) and based on a recorded estimated skill level of the submitting raters, i.e. by weighting the replies by the recorded skill levels of the raters. The rating of each reply may be stored in relation to the reply in submitted replies subdatabase 56. The generated survey may be stored in database 16, for example in a surveys subdatabase 57. The generated survey including the selected replies is sent to raters 20 which may vote to one of the replies, or in some cases to more than one of the replies. The votes may be stored in database 16, for example in votes subdatabase 58, for example, along with corresponding weights associated with the established skill level of the voting raters.

As indicated in block 240, processor 12 may analyze the votes of the raters to evaluate the probability distribution that each of the replies in the survey is the correct answer, i.e. the correct identity of the object. The analysis may be performed continuously, e.g. after each submission of a vote, or periodically, e.g. after each group of vote submissions, grouped by number of submissions or timing of submissions. The analysis may be based on number of votes for each reply in the survey, wherein each vote may be weighted by the recorded established skill level of the voting rater, e.g. votes made by raters with a record of accurate submissions may receive greater weight. Once the probability that one of the replies is the correct answer, i.e. the correct identity of the object, passes a certain threshold, as indicated in block 250, the reply having the highest probability to be the correct answer may be labeled by processor 12 as the identity of the object in question—be it an object, a person, a location, an event, etc. Additionally, the survey may be labeled as ‘answered’ in surveys subdatabase 57.

Reference is now made to FIG. 3, which is a schematic flow-chart illustration of a method for establishing and/or estimating a skill level for a rater for identifying objects according to embodiments of the present invention. After a survey is labeled as ‘answered’, or after a group of surveys are labeled as ‘answered’ (either grouped by number of surveys or by the timing of them being answered), as indicated in block 310, the replies and/or votes each rater submitted in response to an identification task and/or a survey may be compared to the reply labeled as the correct answer. As indicated in block 320, the correctness of a submitted reply and/or vote and the recorded skill level of the corresponding rater may be used to evaluate the level of difficulty of the identification task, which may be recorded in identification tasks subdatabase 54. The set of tasks and their correct answers can grow as more tasks are presented to raters and more replies are received, based on the replies correctness probabilities estimation, described above.

Additionally, as indicated in block 330, the correctness of a submitted reply, for example along with the evaluated level of difficulty of the identification task, may be used to estimate and/or establish a skill level of the corresponding rater which may be recorded in raters subdatabase 52. Additionally, in establishing the skill level of a rater, different questions may be treated differently based on the time and/or type of question.

A rater may have several associated skill levels recorded in raters subdatabase 52. For example, a rater may have different skill levels for different types of question and/or different objects to be identified, based on the rater's history. For example, a rater may have a high established skill level in identifying the identity of people in videos, but a low established skill level in identifying historic events in text fragments.

Reference is now made to FIG. 4, which is a schematic flow-chart illustration of a method for identifying objects according to embodiments of the present invention. As indicated in block 410, the method may include receiving an object indication featuring an object, for example as described in detail herein above. As indicated in block 420, the method may include sending an identification task to a plurality of raters, for example as described in detail herein above. As indicated in block 430, the method may include receiving replies submitted by raters including presumed identifications of the object, for example as described in detail herein above. As indicated in block 440, the method may include determining an identity of an object, for example as described in detail herein above.

Embodiments of the present invention seek to provide an improved system for precise identification of objects, people, places, and events in images, videos, text and sound. As described herein, methods according to embodiments of the present invention may rely on presenting a series of tasks and/or surveys to a mixture of raters with different skill levels with regard to identifying the objects in question, and combining their answers in a way that yields precise results. The method according to embodiments of the present invention may include uploading to a database an image, video, sound or text, which may feature or represent an object to be precisely identified. Examples would be a bag in a photo uploaded for identifying the brand or model of the bag, a person in a video uploaded for identifying their identity, a word or a sentence in a text uploaded for identification of the entity to which it relates, etc. Methods according to embodiments of the present invention may enable a system of databases and raters to produce accurate identifications of objects, wherein the performance of such system is better than performance of a single rater in terms of accuracy.

It will be appreciated that embodiments of the present invention may be used in purchasing branded items, mainly in identifying a certain item as belonging to a certain brand. Additionally, embodiments of the present invention may enable rewarding raters with high level of skill in object/brand identifications.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for identifying objects comprising:
a database; and
a processor configured to receive an object indication featuring an object and to determine an identity of an object by:
sending an identification task to a plurality of raters of a list of raters stored in said database; and
receiving replies submitted by raters including presumed identifications of the object,
wherein the determining of an identity of an object is based on the submitted replies and a recorded skill level of the submitting raters.

2. The system of claim 1, wherein the processor is to determine an identity of an object by:
rating each reply based on number of submissions of the reply and a recorded skill level of the submitting rater stored in said database; and
generating a survey including a plurality of most highly rated replies, for the raters to vote for the presumed identity of the object.

3. The system of claim 1, wherein the database comprises:
a raters subdatabase to store rater details and skill levels of raters;
an identification tasks subdatabase to store uploaded object indications; and
a submitted replies subdatabase to store replies to the identification task submitted by raters and ratings of said replies;

4. The system of claim 2, wherein the database comprises:
a surveys subdatabase to store generated serveys; and
a votes subdatabase to store votes to said serveys.

5. A method for identifying objects comprising:
receiving an object indication featuring an object and storing said indication as an identification task in an identification task subdatabase;
sending an identification task to a plurality of raters of a list of raters stored in a raters subdatabase;
receiving replies submitted by raters including presumed identifications of the object and storing the replies in a submitted replies subdatabase; and
determining an identity of an object based on the submitted replies and a recorded skill level of the submitting raters.

6. The method of claim 5, wherein said determining comprises:
rating each reply based on number of submissions of the reply and a recorded skill level of the submitting rater stored in a raters subdatabase, and storing said rating in said submitted replies subdatabase; and
generating a survey including a plurality of most highly rated replies, for the raters to vote for the presumed identity of the object, and storing said survey in a surveys subdatabase.

7. The method of claim 6, comprising:
estimating the coverage of density of replies to be received in response to a certain identification task;
once the coverage exceeds a first threshold, generating a survey by selecting the top rated replies;
based on received votes stored in a votes database and estimation of skill levels of the raters, evaluating the probability distribution that each of the replies in the survey is the correct answer; and
once the probability that one of the replies is the correct answer passes a second threshold, labeling the reply having the highest probability to be the correct answer as the identity of the object.

8. The method of claim 7, wherein the estimation of coverage of density of replies is performed by a statistical algorithm for density estimation, or Capture-Recapture algorithm.

9. The method of claim 7, wherein the estimation of coverage of density of replies is performed by statistical parameter estimation algorithm or by analyzing for several different time periods the number of different replies submitted in each time period

10. The method of claim 9, wherein the estimation is performed by analyzing the number of repeated submitted replies between the different time periods.

11. The method of claim 9, wherein the replies are weighted according to the skill levels of the raters.

12. The method of claim 7, comprising:
Comparing the replies each rater submitted to the reply labeled as the correct answer; and
evaluating the level of difficulty of the identification task.

13. The method of claim 12, comprising:
establishing a skill level of a rater based on the evaluated level of difficulty of the identification task.

14. The method of claim 7, wherein the first threshold is a certain predetermined coverage of replies density or percentage of the estimated expected number of different replies.

15. The method of claim 6, comprising weighting each vote by an established skill level of the voting rater.

16. The method of claim 7, wherein said estimating is performed after each new submission of a reply.

17. The method of claim 7, wherein said estimating is performed after each group of submissions, grouped by number of submissions or timing of submission.

18. The method of claim 7, wherein said evaluating is performed after each submission of a vote.

19. The method of claim 7, wherein said evaluating is performed after each group of vote submissions, grouped by number of submissions or timing of submissions.

20. The method of claim 13, wherein said skill level is stored in said raters subdatabase.

21. The method of claim 12, wherein said level of difficulty of the identification task is stored in said identification tasks subdatabase.

22. The system according to claim 1, wherein the identification task is a game, wherein the answer is known and wherein the game is used in order to rate the raters.

23. The system according to claim 1, wherein the identification task is associated with a known object usable for determining an identity of an unknown object.
